(19) United States
(12) Patent Application Publication
(10) Pub. No.: US 2022/0391723 A1
(43) Pub. Date: Dec. 8, 2022

(54) Ganaka-2: A Computer and Architecture Operating on Models, Contd

(71) Applicant: G N Srinivasa PRASANNA, Bengaluru (IN)

(72) Inventor: G N Srinivasa PRASANNA, Bengaluru (IN)

(21) Appl. No.: 17/610,697

(22) PCT Filed: May 12, 2020
(86) PCT No.: PCT/IN2020/050430

§ 371 Date: Apr. 8, 2022

(30) Foreign Application Priority Data
May 12, 2019 (IN) 201941018933

(51) Int. Cl. G06N 5/04

(52) U.S. Cl. CPC G06N 5/04

(57) ABSTRACT

Ganaka is a computer which operates using models as operands, and is suitable for big data and machine learning applications. This invention describes how succinct descriptions of data based on convex hulls, and approximations thereof, can be derived, and how efficiently computations can be performed taking into account extreme variability in resource needs. A variety of architectural optimizations is described.

### 1. FIELD OF THE INVENTION

This invention relates to the software/hardware architecture of computers. It enables a general computer and memory system, to operate in a time and resource efficient fashion, using data and models of data. It is an application of the RISC philosophy, to big-data and machine learning applications.

From one point of view, this invention is an extension of ideas in POLYTOPE AND CONVEX BODY DATABASE as claimed in “POLYTOPE AND CONVEX BODY DATABASE” 2464/CHE/2012, “CONVEX MODEL DATABASES: AN EXTENSION OF POLYTOPE AND CONVEX BODY DATABASE” 201641038613, “DECISION SUPPORT METHODS UNDER UNCERTAINTY” 1677/CHE/2008 and related applications, and the provisional application No 201841039665 “Ganaka: A Computer Operating on Models, filed on 19 Oct. 2018”, and incorporates all the ideas therein by reference (some of the description is repeated here for completeness, and this extension In part provides more details, and further generalizations, and additional patents/applications filed by us). This invention further extends convex model databases in representing uncertainty, and in handling “big-data”, both of which are present major issues in data processing. It also further enhances the motion control ideas in U.S. Pat. No. 7,348,754 (Motion Control using electromagnetic forces, and subsequent continuations/divisionals), by facilitation of the use of mechanism kinematic and dynamic control models directly in the computer system, and utilizing the lower force/torque/current/voltage/power drive requirements of the motion actuators (due to the presence of customizable electromagnetic potential energy function, which yields part of the energy/force/torque requirements), to directly drive actuators from the processor i/o pins. The control computations can be performed at high speed also, due to the ability to load control modules into microcode on the microprocessor, exemplarily under user program control or automatically using a machine learning module, trained in a supervised, unsupervised, or reinforcement learning mode, implementing a DNN, a graphical model, or an MRF.

### 2. BACKGROUND

The invention addresses two significant issues with existing computer systems—the difficult of handling huge volumes of data (bigdata), and the dependence of answers on specific realizations of data. Today's Petabyte scale databases pose significant challenges in datacenters, and the answers to many questions depends critically on the exact values present in the data (microstructure), which is not necessarily reflective of large scale properties of the data (macrostructure). The invention addresses these problems.

This invention is a significant extension of the ideas in the EPO number PCT/IN2013/000389, (also Convex Model database) and other applications listed above, and incorporates all the ideas therein by reference.

### 3. DISCUSSION OF THE PRIOR ART

A prior description is in the provisional application No 201841039665 “Ganaka: A Computer Operating on Models, filed on 19 Oct. 2018”, and this extension in part provides more details, and further generalizations (some of the prior description is repeated here for completeness and ease of understanding).

### 4. ABSTRACT and SUMMARY OF THE INVENTION

This invention deals with a data modelling computer and memory system (extended to a database)—which will be referred to as an Ganaka (computer in Sanskrit). Ganaka is especially useful in processing uncertain data, and Big Data, both of which are major issues in the data processing today, and will be referred to as point data in all that follows. Point data are in general multi-dimensional vectors, and can be multi-level pointers themselves.
Definition: A model is a set of point data, and has non-zero measure (volume, count, . . . ). The model can be derived from historical data, or in part/full derived independently of historical data, based on apriori information. Typically the model is stored as a linear or nonlinear non-probabilistic model (polyhedral in possibly non-linear features), or a graphical probabilistic model. It can also be a software/hardware module—a Java package, an FPGA, an ASIC, . . . . In another language, a model specifies a set in a succinct set-builder form, as opposed to listing all the elements seen, and even those possibly not encountered so far. Ganaka's key strength is in methods to work with concise set builder specifications—linear polyhedral specifications, convex specifications, graphical models, etc. . . . . An unbounded amount of data can be captured in a single invariant specification, once it is correctly estimated.

FIG. 1 shows an Ganaka, which adds an inference Engine, to an ALU, and a Model Memory to a conventional Memory. Here F1_ALU refers to the ALU block of the computer in FIG. 1. F1_IE refers to the inference engine of the computer. F1_PDC refers to the program driven controller of the computer. F1_MLC refers to the machine learning based controller block in the figure. F1_DM refers to the data memory block and F1_MM refers to the model memory of the computer. F1_MIO refers to the model I/O while I/O refers to the standard input output.

The Inference engine performs operations on models, which are sets of data. The Model Memory stores models. Similarly the I/O interface communicates either point data or models. The world of data and the world of associated models is kept synchronized, using extensive software-hardware facilities provided for this purpose. The conventional instruction set is extended to include operations on models.

FIG. 2 shows a simplified flow-chart of Ganaka, where a (high bandwidth) stream of point data, is modeled, and then models are dealt with in conjunction with point data if needed. Here, F2_ADC refers to the ADC block of the Ganaka flowchart in FIG. 2. F2_DAC refers to the DAC block of the Ganaka flow chart. F2_FEC refers to the Front end check block of the flowchart. It is critically important to have computationally efficient modeling. Modeling consists of two steps (1) checking if new data satisfies the model (which it should most of the time, if the model is correctly derived to begin with), and (2) updating the model if new point data does not satisfy the model and (3) generating a new model if a data block boundary is reached (or due to other reasons). Datapoints in a model need not be consecutive in the input stream—as described in our preceding application (now PCT/IB2019/001296)
1. Model checkers have to be efficient (high speed, low power, low in memory usage, . . . ), since they are called for each and every datapoint (very high bandwidth). For polytope models Ax<=B, high speed dot-product engines (possibly implemented in dynamic logic e.g. Domino/NORA CMOS), including analog correlators (e.g. Gilbert cells), optical correlators, neuromorphic correlators, may be used, and possibly analog Boltzmann machines for graphical models (along with DAC/ADC's). The model checker is a front end processor for the stream of point data, and makes use of both analog and digital facilities, exemplarily under user programmable control. The user can programmatically enable one or more of these facilities.
   1.1. However, in one embodiment, unlike standard front end processors, each and every input point does not necessarily contribute to an output—those that satisfy the existing model can be dropped, or only a summary statistic maintained of them—their total number of points satisfying the model, their mean, s.d., p.d.f, . . . . Those which do not, trigger a model update, once they become large in number.
      1.1.1. Additionally, the front end can be extensively customized, by using a WCS/uop cache/configurable analog electronics. The processing in the front end need not be and is generally not linear.
   1.2. Analog noise can be tolerated in checkers, with full accuracy digital computation being resorted to in case ∥Ax−b∥^{˜}0.
   1.3. Instead of analog computation, reduced precision digital calculation can be tried. A 64-bit ALU can operate as 8 8-bit ALU's during model check.
      1.3.1. Similarly, simpler polytopes—e.g. choosing matrices A and RHS b with many zeros, unity coeffs, equal coeffs, . . . can be attempted.
   1.4. Model approximations may be used to speed up the process—approximate models (e.g. bounding boxes) can be checked faster, and can be tried first, followed by the full model.
2. Model updates, which are called if a large number of datapoints do not satisfy the existing model, or the existing model is too rough, (and also generate a fresh model if one does not already exist), will be exemplarily based on statistical machine learning methods, and can be quite sophisticated. High speed software packages, possibly loadable into the Ganaka's writeable control store/uOP cache/on-chip reconfigurable FPGA's can be used for this purpose.
3. Of course, models can be specified independently of datapoints also, in which case these issues do not arise.

Processing can be performed using only point data as in a conventional ALU, using the model(s) only, or both, depending on the application. PGPubs, CRC per instructions from the PTO.

FIG. 3 shows point data and associated models in Ganaka. Working with models in addition to point data saves storage (main memory, disk, . . . ), power, . . . , and also enables more general results to be obtained, instead of the results based on only the specific samples (answers are robust).

In the context of databases, the set theoretic and materialization operators discussed previously are extended in this invention to include non-uniform probability distributions, nonlinear models, and are made tractable using the structure determination methods of statistical learning theory and/or neural networks. Automatic learning using backpropagation, and/or log-linear model learning are also discussed.

Ganaka has many applications, in finance, image processing, speech recognition, graphics . . . . Ganaka can be applied to images, speech, weather, travel times for trains and/or planes, medical data, etc. Each domain has additional aspects.

4.1. Datapoints Versus Models

The concepts of the invention Ganaka, and differences from processing of raw data as in a traditional computer system, a memory system, an i/o system, or an RDBMS, are as depicted in FIG. 4 below. There is a world of data samples (scaling to Petabytes and beyond in big data systems), and another world of data models (many orders of magnitude smaller), and the invention integrates and synchronizes the two. The invention can deal with models, completely independent of data points also.

FIG. 4 shows contrasting views of truth. It shows the difference in processing of data by Ganaka and by a traditional computer system. One view to regard data is as manifestation of an underlying generative process—a data generation model. The model may be known apriori (e.g. thermal noise in communication systems), or estimated from the data itself, e.g. a Bayesian network, a Markov Random Field, . . . . Once the data is generated, we can view it in at least two ways, depending on the application
a) Exact reality as in a conventional computer system and
b) Evidence for the underlying model (or models), which is reality.

Compared to a conventional computer system, which operates under viewpoint (a), Ganaka facilitates and synchronizes the usage of both viewpoints (a) and (b).

Note the contrasting view of truth—in the data samples, versus model. Answers produced under viewpoint (a) are at best approximations under viewpoint (b), and vice versa.

1.1.1. Models Offering Insight

The computation using models can be regarded as providing facilities to offer insight into the process for which calculations are performed. As Hamming says
The purpose of computing is insight, not numbers.

The model may be derived from the samples as evidence but could also be ad-hoc derived from known properties of the system being modelled—e.g. flow conservation constraints in networks, deliberately imposed constraints on future events, etc. . . .
A typical but not exclusive assumptions about models is that they include all the observed samples (other than outliers defined in some fashion), and the convex hull of these samples. The exact convex hull for N samples, has a number of facets exponential in N, and approximations can be used for computational tractability.
   Other assumptions include an inner excluding convex hull, where the largest volume hull not including any of the points.
   Both outer convex hull (the conventional convex hull), and the inner convex hull may be used in conjunction, to create a polygonal “ring”, in which the samples are expected to lie.
   Convex regions other than polyhedral can be used in conjunction also.
The number and percentage of outliers can be customized, and the outliers may be optionally stored or discarded. A conventional memory/RDBMS treats all point data as stored outliers. A modeling memory/CmdB treats all point data as belonging to the model. In general the Ganaka computer system operates in between, with both models and point data. Point data are used, when they do not fit the model, or where applications demand exact storage of point data (e.g. financial transactions as opposed to analysis of financial strategies, where models can be used).
Ganaka's architecture includes
   A portion which handles point data, and/or models, and estimates/updates models. This may include deep pipelines as in conventional GPU's to perform Matrix-Vector operations, analog compute engines, . . . .
   A portion which operates on models, and generates inferences on models. This may use the same deep pipeline as in (a), for statistical machine learning algorithms, augmented with facilities to handle highly data dependent execution. But broadly the architecture is different from conventional machine, due to in part the small memory footprint of models.

I.1.1. Models in Set Builder Form

Of course when the models are derived from data (e.g. “big-data”) there are typically far fewer models compared to data samples. The key insight of the invention is specification of models in set builder form (e.g., as polyhedral specified by matrices, graphical models by graphs and CPDFs, . . . ), and computation on these sets directly, using high speed/low memory/low power/low resource software-hardware implementations. Compared to conventional machines, Ganaka works with small datasets (models), but with complex operations on them. Traditional machine optimizations like deep pipelining, hazard detection with large windows, Out-of-Order execution, etc, either need not be used, or manifest themselves differently in Ganaka.

Clearly, whenever possible, using models under viewpoint (b) in-place of data samples under viewpoint (a) helps compress storage, increase speed, and reduce power, in the computer system, a technical improvement.

At the highest level, the entire computer system Ganaka (ALU, Memory, I/O), deals quickly and efficiently, both with individual datapoints (point data, as denoted earlier), and with models, benefiting several applications. In addition to arithmetic/logical operations per second, bytes/words of memory, and words/second of i/o throughput, we deal with model operations per second, number of models stored in memory, and models/second of i/o throughput.

Below we describe several specific embodiment of the invention, but it should be understood that the invention is not limited to these embodiments but covers all others variations of any part or the whole of the invention. The invention may be implemented in computer software, hardware, or firmware, as an ASIC, an accelerator, as an analog device, or whatsoever, and all such variations are covered by this description.

### 5. BRIEF DESCRIPTION OF THE DRAWINGS

FIG. 1 Modeling Computer Ganaka . . . 6

FIG. 2 Ganaka Flowchart showing Modeling Portion, including provisions for analog/optical conversion . . . 7

FIG. 3 Point Data and Associated Models in Ganaka . . . 9

FIG. 4 Contrasting Views of Truth . . . 10

FIG. 5 Structure of Inference Engine . . . 15

FIG. 6 Structure of Inference Engine and ALU in Ganaka (adapted from our preceding application No 201841039665 “Ganaka: A Computer Operating on Models, filed on 19 Oct. 2018”) . . . 15

FIG. 7 Exemplary Operation of IE in Ganaka (adapted from our preceding application No 201841039665 “Ganaka: A Computer Operating on Models, filed on 19 Oct. 2018”) . . . 16

FIG. 8 Graphical Model in Ganaka, and associated 3-D Polyhedron showing Y and Z conditionally independent given X . . . 17

FIG. 9 Set Theoretic Relational Algebra in Ganaka using comparison of rectangles (intersecting polyhedra) . . . 17

FIG. 10: Alternative Materializations in Ganaka preserving volume. Alternative ‘materializations based on changes only in y and z, preserving y-z area (Non-Convex Polyhedron) . . . 18

FIG. 11 Comparing Two different 3-variable Bayesian Networks . . . 19

FIG. 12: Set Theoretic Operations in Ganaka from Graphical Models . . . 20

FIG. 13 General Operations over Bayesian Networks . . . 20

FIG. 14: Convex Hull of datablock: M Datapoints constituting the convex hull vertices are selected (marked as 1), and (N-M) others unselected (marked as 0) . . . 21

FIG. 15: Few Training Data Points->Many Training Data Points . . . 25

FIG. 16 Set Theoretic Operators from Graphical Models . . . 27

FIG. 17 Operator Evaluation Optimization(Varying Time/Memory/ . . . Resource Usage) . . . 30

FIG. 18 Exemplary Memory Heirarchy Including Caching . . . 32

FIG. 19 Computation Exemplarily Starts with Partial Operand Arrival . . . 33

FIG. 20 WCS Scheduling Computations with very different timings, memory, and resource needs . . . 33

FIGS. 21 (a) and (b): FIGS. 23 and 24 from prior application . . . 36

FIG. 22 Long Tasks are executed in any core, with data frequently stored in shared global memory (private memory flushed to global memory periodically) . . . 37

FIG. 23 Details of a Ganaka Embodiment . . . 39

FIG. 24 Data Memory and Model Memory, where the model memory is an exact or approximate convex hull of blocks of datapoints . . . 42

FIG. 25 Showing Scheduling of Ganaka's Instructions in Dynamic Instruction Window (size changes w.r.t instruction complexity). Memory, Processor, and 10 interfaces are non-blocking, and computation can start as soon as sufficient parts of operands arrive. Enhanced I-structure updates are made as soon as results/partial results are available . . . 46

FIG. 26 Nonlinear DNN Model . . . 48

FIG. 27 Convolutional Layer in a Convolutional Neural Network . . . 50

FIG. 28 Convolution operation followed by the maxpooling operation . . . 50

FIG. 29 3×3 Convolutional Filter . . . 51

FIG. 30 Showing confusable inputs using same features . . . 53

FIG. 31 Example of inversion with original class 8 and confusing class 3 . . . 54

FIG. 32 Plots showing features of the original image and the confusing example . . . 54

FIG. 33 Example of inversion with original class 8 and confusing class 9 . . . 55

FIG. 34 Example of inversion with original class 4 and confusing class 4 . . . 55

FIG. 35 Functional Diagram of Inverter . . . 56

FIG. 36 Exemplary Ganaka Program . . . 57

FIG. 37 Ganaka showing FPGA enabled ALU (1-0 not shown for clarity) . . . 58

FIG. 38: 64-bit Ganaka . . . 61

FIG. 39 Execution Engine Partitioner/Scheduler Control Signals . . . 62

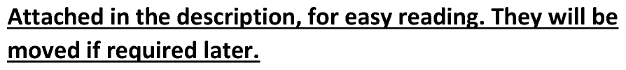

### 6. DETAILED DESCRIPTION OF THE INVENTION

A first embodiment of Ganaka is a computer system. A special case is a memory device embodiment, and a use of the memory device, results in a database embodiment. The extension to an i/o device is exactly analogous to the memory device (models are communicated, in conjunction to point data).

Extensive details, of the invention can be obtained from our preceding application No 201841039665 “Ganaka: A Computer Operating on Models, filed on 19 Oct. 2018”, which is included in its entirety by reference. We describe extensions in this document, while partly repeating some of the earlier description for ease of reading.

### 7. A FIRST EMBODIMENT AS A COMPUTER SYSTEM: GANAKA

A general view of this invention is as a computer system handing both point data and models as the basic data objects. Instead of bytes or words, we additionally talk about models. Performance has to be exemplarily measured in models analyzed per second for the ALU (here called the inference engine), models stored per Megabyte of memory, and models transmitted per second over interconnect.

Models are sets of atomic objects, and the basis operations are deal with sets. The architecture has facilities to do this at high speed.

Datapoints can be analyzed to configure/improve models, and estimate answers of model operators. Models can be sampled to obtain new datapoints, and models can be analyzed/optimized to obtain answers to set/information theoretic operators.

The models are designed on an application specific basis—ranging from simply listing all the datapoints, a statistical summary, an enclosing polytope/convex body to facilitate (convex) optimizations, a graphical model facilitating machine learning/ . . . , etc. The models should be computationally tractable, and accurately fit the data (plus possibly additional unseen data, based on assumptions about system behavior, or the degree of approximation needed—e.g. convexification), being modeled (except in the case when the model is known apriori).

Further details, including but not limited to the general architecture, the inference engine, I-structures, linking models and datapoints, in a consistent, two way manner, etc, can be obtained from our preceding application No 201841039665 “Ganaka: A Computer Operating on Models, filed on 19 Oct. 2018”. We describe extensions in this document. By default the words I-structure and Enhanced-I-Structure (an extension) are synonymous. Some portions of the preceding applications are repeated for ease of understanding.

Ganaka's IE (FIG. 6) is an ML/AI system, and exemplarily uses approximations, transitivity and apriori properties, apriori structure, and operator scheduling, together with basic algorithms, to improve performance—speed, memory, i/o, . . . .
Approximations replace complex operands with simpler to analyze operands
Transitivity and other properties are operator properties which simplify analysis
Operator scheduling attempts to minimize work based on all the above.

FIG. 6 shows structure of inference engine and ALU in Ganaka. F6_IE refers to inference engine, F6_DS refers to the data stream, F6_EIS refers to the enhanced I-Structure and F6_PLI refers to the programming language interface and controller block.

FIG. 7 shows exemplary operation of IE in Ganaka. F7_PLI refers to Programming language interface and controller block which acts as input to the data block. FIG. 7 shows an exemplary flow of control for the IE, which is determined using the programming language interface, and/or the controller in FIG. 6. In this figure, an I-structure check is first made, and then approximations (convex, non-convex, graphical), are tried, and only then the full heavyweight operator is exercised. If the resource exceeds a limit, then partial answers/state can be stored.

In essence, Ganaka learns the data model(s), and uses the data model(s) in conjunction with the datapoints, as far as possible. Ganaka utilizes properties of basic operators like transitivity, associativity, approximations, . . . to further improve performance. Results are cached in the I-structure. Ganaka can and typically does learn different models for different regions of dataspace. Some of the models may be based on apriori information, and not necessarily derived from data. The choice and scheduling of operators is exemplarily based on Machine Learning, in a supervised or unsupervised manner.

7.1.1. Learning and Inferencing in Bayesian Networks

Here we describe how the (sparse) structure of Bayesian networks computationally simplifies set/information theoretic operators in Ganaka. We show several examples.

FIG. 8 shows graphical models in Ganaka and associated 3-D Polyhedron showing Y and Z conditionally independent given X. Polytope 101 and Polytope 102 are two such models.

FIG. 9 shows set theoretic relational algebra in Ganaka using comparison of rectangles (intersecting polyhedra 103 and 104).

FIG. 10 shows alternative materializations in Ganaka preserving volume. Alternative materializations based on changes only in y and z, preserving y-z area (Non-Convex Polyhedron). Materialization 101 and Materialization 102 are two such materializations.

These exemplary embodiments in FIG. 8, FIG. 9, and FIG. 10, show a Bayesian Network, and its associated (non-convex) polyhedron, and have the following implications. In the Figure above y and z are conditionally independent given x. Hence in the y-z plane they satisfy one or more linear box constraint (s)

Ymin(x, . . . )<=y<=Ymax(x, . . . )

Zmin(x, . . . )<=z<=Zmax(x, . . . )

The support region is clearly a rectangle (or a set of rectangles arranged in a rectangular grid) in the y-z plane, whose dimensions depend on x and possibly other variables. Set and Information Theoretic operations on such an entity can be computed much faster than using general Mathematical Programming Techniques ignoring structure (FIG. 8, FIG. 9, FIG. 10). With reference to the same figures, checking if two models M1 and M2, with the same Bayesian Graphical Structure, intersect involves determining a value of “(x,y,z)” satisfying:

Ymin1(x, . . . )<=y<=Ymax1(x, . . . )

Zmin1(x, . . . )<=z<=Zmax1(x, . . . )

Ymin2(x, . . . )<=y<=Ymax2(x, . . . )

Zmin2(x, . . . )<=z<=Zmax2(x, . . . )

Ymin1( ), Zmin1( ), Ymin2( ), Zmin(2), corresponding to M1 and M2, are general, possibly nonlinear functions of x. If there is no such “(x,y,z)”, then the two models are disjoint else they intersect If M1 and M2 are both convex, then both the X's and Y's are linear functions of x, and checking if the intervals along y and along z overlap at the minimum and maximum values of x, yields the answer. Checking if M1 is a subset of M2 (or vice versa) reduces to checking if the interval [Ymin1, Ymax1] is a subset of [Ymin2, Ymax2], etc, for each “x”. Linear programming is not needed.

FIG. 11 shows another example, with two differing three variable Bayesian networks. Materialization 101 and Materialization 102 are two such networks.

In a general setting, comparing two different Bayesian Neworks (BNs) hence does not need a general LP or a non-convex optimization algorithm—one needs to sweep along a parent variable of one BN, and see if the regions of the other BN corresponding to this variable intersect. In general, with a model M1 and a model M2, we do steps (1) and (2) below, which propagates the known information through both models.
1. Start with a root/parentless node of M1, and find the allowable intervals of all its children in M1, and all nodes connected to it in M2.
2. Repeat (1) with the children in both M1 and M2. If at any time, we encounter a node we have seen before, the graph of M1/M2, or the union of the graphs of M1 and M2 has a cycle. In the latter case we have to find fixed points numerically.

After this step is done, and it is determined that the intersection is non-null, we have to evaluate operators numerically, using methods like MILP, MCMC, . . . .

Graphical models (which need not specify polyhedra in general) can be adjoined, and tested if the models can be jointly true or not. In FIG. 12 (a), models M1 and M2 intersect, if the probability of node N being 1 is non-zero. In FIG. 12(b), if we prove that M1 implies M2 at node N, then the model M1 is a subset of model M2, which is equivalent to determining that the probability of the event (M1 and (not M2)) is zero. Clearly this method extends to determining probabilities of jointly being true or not, and also probabilities of arbitrary logical expressions in First-Order-Logic and other logical systems. Any algorithm can be used, and can be written in the WCS (writeable control store).

Information theoretic operators can be also simplified. Referring again to FIG. 10, we show two materializations 101 and 102, where the cross-sectional area (analytically computable for a hyper-rectangular region), is preserved in the y-z plane, at each value of x, and other relevant variables, preserving the total volume of the polyhedron, and by implication the information content. This can be checked by estimating the probability of materializations 101 and 102, using a variety of standard methods.

Further details of set and information theoretic operations are in Section 7.6.

FIG. 13 shows general operations over Bayesian networks. The block in the figure shows operations over the space of models.

7.1.2. Learning and Inferencing in Markov Random Fields

This is analogous to Bayesian models, and described further in the prior application PCT/IB2019/001296.

7.2. Convex Models, Variants of the Convex Hull

This is a feature of Ganaka useful in handling big-data systems possibly operating with high speed data interfaces. In this invention, a set of datapoints are replaced by a succinct model which includes all those and possibly other points—and the tightest convex model is the convex hull. However, estimation of the convex hull introduces significant complications, as the number of facets is exponential in the number of dimensions—and alternative approaches are described below.
The convex hull is generally very noisy, and it is important to estimate a smoothed version of the typically noisy convex hull, which includes all the datapoints seen so far. We present algorithms for these, and discuss the implications for I-structures:
(Re)estimating a model is computationally expensive, and should be infrequent, and carried out only when a large number of points do not satisfy the model. As such, it is of critical importance to have fast algorithms for checking if a new point satisfies a model (no model update—see Section 7.8), or vice versa (model has to be updated).

FIG. 14 shows convex Hull of datablock in which M Datapoints constituting the convex hull vertices are selected (marked as 1), and (N-M) others unselected (marked as 0). It shows raw data as input at high speed and model data as output at low speed.

N datapoints Xi arrive in a given class C, and the convex hull of all data in C seen to date (denoted by its arbitrary member X) is constructed according to the Linear Program

$$X = {\sum }_{0}^{N - 1} {α}_{i} {X}_{i} ; {\sum }_{0}^{N - 1} {α}_{i} = 1 ; {α}_{i} \geq 0$$

From N input datapoints, an unbounded number of new points inside their convex hull can be generated. By checking if any of the Xi's are convex combinations of others (by say, setting X to Xi0, for some i0, we can iteratively identify which M<=N of the Xi's are on the convex hull, and reduce the size of the LP considerably.
Hardware support has to be given for solving the linear program corresponding to the implicit convex hull—converting it to an explicit facet representation involves in general an exponential blowup in terms of the number of facets. It is assumed that the points Xi are already stored/storable, but all of them need not be used for this implicit representation. This does not hold for an explicit representation as facets—this is exponential in the number of dimensions of Xi
It can be used in conjunction with other constraints directly specifying facets in X space.
Choosing different values for the W's enable one to generate an infinite number of points inside the convex hull. Once the convex hull has been implicitly generated, any number of new points can be generated by sampling inside it—a uniformly distributed choice of a will lead to a uniformly distributed set of samples inside the convex hull.

Note that explicit constraints (linear combinations of components of X) can be added to this implicit convex hull, if required.

The method is superior to using metrics like the class C mean, and distance between class means, since it additionally incorporates possibly asymmetric class cluster shape (assumed to be a superset of the convex hull of observed points in the class).

Overlap between classes (set theoretic relational algebra), margin distance between classes, . . . , can be found using linear/convex programming, as is known in the state-of-art of SVM (support vector machines).

Inner/outer approximations (subset/superset of the convex hull), can be similarly used, under programmatic control. Inner approximations are subsets of the convex hull, outer ones are supersets, and can be similarly checked. The type of approximation (using substitutive/complementary/general constraints/ . . . can be programmatically selected).

7.3. Relational Algebra with a Mixture of Constraint and Convex Hull Specification.

TABLE 1
Set Theoretic Operators with varying specification of Polytopes P1 and P2.
Constraint Form: P1 Ax1 <= b1; P2 Ay1 <= b2. Convex Hull form P1 Convex Hull of Xi′s
(Sum of alphai Xi′s), P2 Convex Hull of Yi′s (Sum of betai Yi′s).

| P1 Op P2 | Disjoint | Intersection | P1 Subset of P2? |
|---|---|---|---|
| P1, P2 | A₁X ≤ b₁; | A₁X ≤ b₁; | Negate each |
| constraint | A₂Y ≤ b₂; | A₂Y ≤ b₂; | constraint of P2 and |
| | X = Y | X = Y | check for feasibility |
| | Infeasible | Infeasible | |
| P1 Convex Hull, P2 Constraint | $X = {\sum }_{0}^{N - 1} {α}_{i} {X}_{i} ;$ | $X = {\sum }_{0}^{N - 1} {α}_{i} {X}_{i} ;$ | ${X}_{k} = {\sum }_{0}^{N - 1} {α}_{i} {X}_{i} ;$ |
| | ${\sum }_{0}^{N - 1} {α}_{i} = 1 ; {α}_{i} \geq 0$ | ${\sum }_{0}^{N - 1} {α}_{i} = 1 ; {α}_{i} \geq 0$ | ${\sum }_{0}^{N - 1} {α}_{i} = 1 ; {α}_{i} \geq 0$ |
| | A₂Y ≤ b₂; | A₂Y ≤ b₂; | A₂Y ≤ b₂; |
| | X = Y | X = Y | X = Y Feasible for |
| | Infeasible | Feasible | all k ∈ [0 · · · N − 1] |
| P1 Constraint, | As above, with x,y | As above, with x,y | Negate each |
| P2 Convex Hull | interchanged | interchanged | constraint, and |
| | | | check intersection |
| | | | with convex hull of Yi |
| P1 Convex Hull, | As above, with αᵢXᵢ | As above, with αᵢXᵢ | Check if each Xi is in |
| P2 Convex Hull | for P1, and βᵢYᵢ for P2 | for P1, and βᵢYᵢ for P2 | the convex hull of Yi |
| P1, P2, Mixed | | | |

7.4. Reduction in Number of Points by eliminating Redundancies, Clustering, and Approximation.

It is of critical importance to store the datapoints used to form the convex hull efficiently in the memory. Clearly each and every datapoint Xi (or Yi) need not be stored (there can be billions and even trillions of them)—if they are in the interior of the convex hull. New data can be checked for being in the interior of an existing convex hull, using the LP formulation, and higher speed algorithms. Points in the interior can be dropped, and/or flagged to be moved to secondary storage, and the storage reclaimed by garbage collection techniques well known in the state-of-art.

7.4.1. Reduction in Number of Convex Hull Points by Clustering.

An optimization is to cluster the datapoints Xi (and/or Yi), into a small number of clusters, based on methods known in the state-of-art of statistical learning—e.g. points within a maximum distance of each other can be treated as a cluster, and represented by their mean/median (using methods like K-means, K-medians, . . . ). The convex hull of the much smaller number of cluster mean points can be determined using the αi's/βi's above, and/or determining facets, if the number of dimensions is small. Since the datapoints in a cluster (easily 1000's of points, if a storage reduction of ×1000 is needed), are represented by their cluster mean, all the data points are not convex combinations of the cluster means (there will be a residual error in most cases

This method is the dual of the clustered German Tank approach presented in our earlier work, where the facet coefficients were clustered. Here the vertices are clustered.

7.4.2. Reduction in Number of Convex Hull Points by Approximation.

Further reduction can be obtained using approximation methods, by minimizing the distance (using an appropriate norm) between a new point and the nearest point on the existing convex hull—a convex optimization.

A new point is dropped if for a suitably chosen threshold T,

Min over ∝ᵢ∥xₖ−Σ∝ᵢxᵢ∥≤T;Σ∝ᵢ=1;∝ᵢ≥0

else it is included as a new point in the convex hull. Any norm can be used.

This approach greatly reduces the number of points needed. For an example, consider a polygon as the convex hull of N symmetrically spaced points approximating a unit circle, the distance (i.e. error) between the exact convex hull (the circle, needing an infinite number of datapoints for exact estimation), and the best approximation using the points in the polygon is

$$1 - cos θ \sim \frac{1}{2} {θ}^{2} \sim {\frac{1}{2} [ \frac{π}{N} ]}^{2} ,$$

for small θ, where θ is half of the angle between two adjacent diameters of the polygon. For n=10, the best approximation has an error bounded within 5% of the radius, and it for n=20 it is down to 1.25%. Hence just a few 10's of points are sufficient to approximate any point in the boundary of the circular region within errors of a few percent. The data compression obtained is clearly very large (unbounded in principle). The dropped points can be stored in lower speed/power/inexpensive storage, if needed for other purposes.

7.5. Inversion of Networks.

The sampling inside the convex hull, can specifically be applied to the feature layer of a DNN (and generally in any classifier system, at the linear classification layer). When inverted back to the input, using methods previously discussed, we can create new input examples corresponding to a class, using can be used for (a) enhancing the training data set by creating new examples IN corresponding to class C itself and (b) checking robustness by creating new examples IN′ corresponding to a different class C′ (confusing examples).

In some applications, IN′ should belong the convex hull of the input data corresponding to class C′. However, to get the same visual feel, in an image processing application—e.g. medical imaging, it is more appropriate to take a sample of the input class data as the prototype inversion target (or the convex hull of input class data close to each other visually, or optionally certified by another trusted forward (inferring) classifier). The inverting and forward classifiers need not be the same.

The sampling can also be applied to any layer in a DNN, but the convex hull cannot be directly used (the inversion of the convex hull at the feature layer to the layer in question is needed).

In the case of an application like health care, one can collect relatively few samples (1000's) and generate others using this method (10,000's). This is of significant utility, as medical samples are expensive and involve privacy/data sharing issues—see FIG. 15 (and also the description later in Section 7.9)

FIG. 15 shows transformation of few training data points to many training data points. This is done by deriving a model, and then using the model to generate new data points in a generative manner. F15_CMDB refers to the Convex model data memory in FIG. 15 (and also those in our prior patents and patent applications)

7.6. Inferring Set Theoretic Operators from Graphical Models: Additional Details.

As discussed in Section 7.1.1, and Section 7.1.2, Multiple models in Ganaka can be structured as Statistical models (decision tree, random forest, Bayesian Networks, MRF, . . . , neuroscience based). Datastructures and pointers, are as described in the prior Ganaka application (provisional application No 201841039665 “Ganaka: A Computer Operating on Models”, filed on 19 Oct. 2018), and further extended here. Techniques well known in the state-of-art—storage as graphs, tabular or parameterized representation of CPDF's are further used in Ganaka.

I-structures can be inferred directly from Graphical Models, where the nodes represent aggregations of states of variables, which need not be convex. We illustrate this by representing how relational algebra operators can be derived from Bayesian Networks and Markov Random Fields satisfied by the variables, denoted by X, Y, Z, . . . . For simplicity of description, in this provisional application, we will frequently use simplified intuitive definitions of dependence. These will be translated to standard notation in Bayesian Networks and Markov Random Fields subsequently.

The key idea is that the factorization of the PDF implicit in graphical models directly lends itself to simplifications of operators.
The volume of a model, is a set is the probability of the set under a uniform distribution. Hence all known methods to determine probabilities in graphical models directly apply to information-theoretic operators working with operands which are graphical models.
Set theoretic operators can be evaluated similarly. The intersection of two graphical models is null iff the probability of the event denoting their intersection is zero. A graphical model A is a subset of another graphical model B, iff the probability of (A and (not B)) is zero.

7.6.1. A Simple Example

Assuming that PDF marginals of X, Y, and Z, are bounded in extent (the distribution is unknown).
Bayesian Network case: Assuming that X, Y, Z are all independent
   X,Y is a superset of X->Y
   X,Y,Z is a superset of X->Y, X->Z, since the extent of Y, Z is modulated by X
Markov Random Field case: X,Y is a superset of X-Y

Both these cases are illustrated further below:

FIG. 16 shows set theoretic operators evaluated at high speed in graphical models. F16_RS1 and F16_RS2 refer to two regions of support of joint PDF. Assuming that X is independent of Y, the region of support of the joint PDF is RS1
If X->Y, then the region of support of the joint PDF RS2 is a subset of RS1. The same holds for a Markov Random Field (undirected arrow), since the dependency is a constraint, not necessarily holding for all (X,Y), in RS1.

Such inferences can be used to infer I-structure relationships directly from the graphical model, even if non-convex, as in the case above.

7.6.2. The General Case

This can be extended for general Graphical Models with more complex networks. For simplicity, we assume that all models have the same variables, with the same marginal distributions (and hence the same support) of all variables. If the marginal are different, we are exemplarily dealing with very different situations, and numerical evaluations have to be carried out for set-theoretic and information theoretic operators.

Lemma: The union of the edge set of two graphical models (over the same variables, whose marginals are the same in both models) defines a graphical model whose support subset is common to both (the intersection of the supports of the two models).

In the notation of graphical models, (X⊥ (independent of) Y given Z), implies that the support region for [X,Y] is a rectangle (or a rectangular grid of rectangles), who location and dimensions depend on Z. Set theoretic and information theoretic operators are based on intersection, subsetness, and area/volume of rectangular regions, which is clearly simpler than in the general case where X and Y can have arbitrary support.

Algebraic expressions are written and simplified similar to those corresponding to FIG. 7, FIG. 8, and FIG. 9, and symbolic algebra doing propagation of knowledge about constraints across models, instead of LP/ILP, is used to infer. With reference to FIG. 16a

For model (a)

Ymin1(x, . . . )<=y<=Ymax1(x, . . . )

Zmin1(x, . . . )<=z<=Zmax1(x, . . . )

Wmin1(v(k(z))), . . . )<=y<=Wmax1(v(k(z)), . . . )

Umin1(v(k(z))), . . . )<=y<=Umax1(v(k(z)), . . . )

For model (b)

Xmin2(y, . . . )<=x<=Xmax2(y, . . . )

Zmin2(y . . . )<=z<=Zmax2(y, . . . )

Vmin1(w(x), . . . )<=y<=Vmax1(w(x) . . . )

Umin1(w(x), . . . )<=y<=Umax1(w(x) . . . )

Ymin1( ), Ymax1( ), Zmin1( ), Zmax1( ), are general, possibly nonlinear functions of x/y/ . . . , v is a possibly nonlinear function of k, which is a possibly nonlinear function of z, . . . , and similarly for the others. This yields a set of algebraic inequalities, which have to solved to yield a point in the intersection. If the functions are linear, we get a (simple) IP. These simple LP's can be solved by sweeping one set of variables corresponding to the parents in one model, and seeing if the resultant regions of support (rectangular/grid of rectangles), intersect with the other model (or any other method).
General LPs or other statistical/machine learning techniques, are used only if this approach does not work.

A similar approach can be used for Markov Random Fields, where the edges are undirected, and reflect independencies between nodes separated by a cutset.

These special purpose algorithms can be exemplarily stored in the writeable control store (WCS), and the models in a shallow memory hierarchy.

7.63. Inferencing Set/Information theoretic Operations, from Deep Neural Networks
Set theoretic and information theoretic operations on two or more DNN's for the same classification task, can be done if the features are the same in the networks, and reduces to polyhedral comparison.
It can also be done if we invert both networks, using the LP formulation for ReLU, and checking for feasibility/disjointness/subsetness, keeping both the input layer and output layer as variables. The fully connected layers require linear approximations for the activation functions, for the LP to be used.

7.6.4. General Operator Evaluation and Architectural Implications

As such, graphical models allow us to compute set-theoretic operators, and hence generate I-structures (or enhanced I-structures) automatically, without using complex integer linear programming/full blown graphical model methods. In general, a dependency line signifying an event, indicates that it is a subset of the event lacking that line (assuming that everything else in the graph is the same, including the marginal and conditional p.d.fs). If the graph structures are the same, set theoretic properties require analysis of conditional distributions. All this avoids the ubiquitous use of LP and ILP and other heavyweight algorithms for set-theoretic operations.

In general, evaluation of the set-theoretic operators (in general heavyweight operators) on a set of operands represented by polyhedral or general models, proceeds by (FIG. 17). FIG. 17 shows operator evaluation optimization (varying resource usage). F17_SAO refers to the symbolic Algebra optimizations block, F17_GSO refers to the graphical structure optimizations block, F17_IS refers to the I-Structure, F17_OEC refers to the operator evaluation controller block.
1. Preprocessing to identify common constraints, expressions, . . . , and direct inferences based on these (symbolic Algebra Optimizations)
2. Inferences based on graphical structure, based on the discussion on graphical models above.
3. Inferences based on numerical evaluation—e.g. solution of MILP's as per preceding patents/patent applications (including the methods in our preceding application No 201841039665 “Ganaka: A Computer Operating on Models, filed on 19 Oct. 2018”), inferences using the graphical structure and CPDF's, . . . .
4. Prior computations can be accessed at any time from the I-structure for further optimization.

Information Theoretic Operators and associated I-structures, can be similarly analyzed. The various subsystems can be invoked with programmable control flow exemplarily co-ordinated by the operator evaluation controller. Some or all of this code can be present in the writeable control store.

The memory needs are modest, as models are extremely compressed representations of voluminous data. As such traditional deeply pipelined architectures (ALU, memory, . . . ) are not required.

However, the size of objects, the time take to process operators, . . . varies widely (constant to exponential in the model dimensions), and a possibly self-timed system with a scoreboard listing progress so far is a good embodiment of the invention.

Notation: An operand is a model, which may be a constraint, a polytope (set of constraints), a single datapoint (degenerate polytope), or a graphical model, . . . .
Each operand is of variable size, depending on model complexity. Hence an operand fetch can take a highly variable amount of time, depending on model complexity
   Very common operands include
      (Infinite) Polytopes defined as the positive orthant over N-D reals or integers.
         These can be succinctly stored using a single bit flag, saving considerable space
      (Infinite) Polytopes of the form (x>=b). The single bit flag along with the vector b suffices to store them.
   Computation can begin as soon as enough of the operand (say the first coefficient in a polyhedral model, the first edge in a graphical model) is available to the Inference Engine. This requires the IE to be controllable to start computation as soon as an operand partially arrives.
Each operator can take variable time, depending on the complexity, and precomputation in the I-structure, approximations, etc.
   Multiple operators, on the same and/or different operands, can be run on parallel threads, and “emergent structure” observed as relationship links fill in.
Memory can be shared between operands, e.g. a constraint can be part of several polytopes, with only a single copy in a register file/cache/memory.
   The sharing can vary between different constraints, with commonly used operands shared across all threads, and others between a few threads only, depending on application.
   Namespace translation can be used to further compress memory.
Operands can be cached, with the cache replacement depending not only on the time of last use, but also utility of the operand/operator combination. For example, an operand which has many subsets, would generally be kept in memory, due to the many inferences which can be drawn from it.
   The cached data can be shared between threads, with coherency as per methods analogous to generic machines (directory based, . . . ).
From a general point of view, the Ganaka has to handle computations with very different resource needs—ranging from single clock cycle execution for pointdata and bounding boxes, to exponential (in number of model dimensions) time, memory, i/o needs for graphical and non-convex models. All existing and to be invented methods for resource scheduling can be used in Ganaka, ranging from Earliest Deadline First, Shortest Job First, . . . . All the above can be under program control, exemplarily in the writeable control store, controlling all or some of the cores (WCS). These are depicted in FIG. 18, FIG. 19, and FIG. 20

FIG. 18 shows an exemplary memory hierarchy including caching. F18_LCC refers to local constraint cache and F18_GM refers to the global memory which includes a global constraint pool(variable sized constraints/polytopes/graphical models), as per our prior patents and patent applications.

FIG. 19 shows computation that exemplarily starts with partial operand arrival. F19_LCC refers to local constraint cache and F19_GM refers to global memory including global constraint pool with exemplarily namespace translation.

FIG. 20 shows WCS scheduling computations with very different timings, memory, and resource needs. F20_GM refers to global memory including global constraint pool with exemplarily namespace translation.

7.7. Details of an Exemplary Embodiment

The elementary computation elements (e.g. in FIG. 18, FIG. 19, FIG. 20), referred to in this exemplary embodiment are RISC cores, but some or all of them can be CISC or even analog accelerators (e.g Boltzmann machines) respecting the same interface semantics (non-blocking operand fetch, computation with partial operands, . . . ). These elementary computation engines (conventional RISC cores), serve as a micro-architecture kernel, implementing Ganaka's instructions, which follow a CISC philosophy.

7.7.1. Ganaka Architecture: Model and Computation Engine

The architecture as per our WIPO patent application PCT/IB2019/001296 is shown in FIGS. 21 (a) and (b) (the label suffix numbers 23 and 24 are taken from that application, and do not follow the order in this application—this is done for ease of reference). Further details of this embodiment are given below. A 64-bit implementation is in Section III (FIG. 38)

In all that goes below, we use the word WCS to mean a writeable control store and/or a uCode and/or a nanocode memory. Such an architectural element is as is well known in the state-of-art, unless explicitly mentioned below.

In FIG. 21 (a), F23_PI refers to programming interface, F23_MT refers to model type, F23_DPT refers to pointer to data, F23_MPT refers to pointer to model, F23_OC refers to pointer to operator code, F23_FM refers to non linear feature map, F23_MO refers to model, F23_TIF refers to training inference for model F23_MM refers to memory manager, F23_CP refers to constraint pool, F23_NPT refers to namespace translation and F23_GF refers to global facilities.

In FIG. 21 (b), F24_SM refers to scratchpad/temporary memory, F24_IS refers to I-Structure, F24_ISC refers to I-structure controller, F24_UC refers to ucode, F24_IM refers to instruction memory, F24_MM refers to model manager, F24_MOM refers to model memory, F24_MIO refers to model I/O, F24_NM refers to nonlinear model, F24_M1 refers to model inverter, F24_MS refers to model sampler, F24_S refers to summarizer, F24_DM refers to datapoint memory and F24_DIO refers to data point IO.

FIG. 22 shows that long tasks are executed in any core, with data being frequently stored in shared global memory (i.e. core private memory is flushed to global memory periodically).

7.7.1.1. Processor and Core Partitioning and Scheduling in Ganaka

Due to the extreme variability in time/memory/io resource requirements, amongst operators, the available resources (processors, memory, io) have to be partitioned and scheduled ideally dynamically, with pre-emption allowed. This is the case irrespective of whether RISC cores, digital accelerators, analog accelerators, . . . are used as the elementary computation engines. A scoreboard may be used to signal completion of computation/memory access/communication events.

The partition/scheduling is based on resource estimation, which can be a machine learning package, with input both the problem, and the state of the Ganaka computer system. The machine learning package is trained on the resource requirements of different versions of the problem.
For operation on datapoints, the WCS control is exactly the same as a conventional machine, and passes the operands to the RISC core, in this embodiment. In other embodiments, e.g. those with analog accelerators attached, only the RISC portion of the core will deal with datapoints.
For convex models possibly on accelerators, estimates from the ML system, as well as asymptotic polynomial time scaling are used to estimate resource needs.
For general models, possibly on accelerators, the ML estimates, together with pre-emption/convexification is used.
Convexified approximations (possibly already present in the enhanced I-structure), can be used to cut-off unneeded computations, similar to fathoming in MILP algorithms.
In general, the absolute and asymptotic resource utilizations of algorithms for each of Ganaka's ISA operators, are used in these estimations.

This will enable close-to-optimal scheduling of the operators, on one or more cores/accelerators/analog accelerators.

7.7.2. Major Modules of this Embodiment

In FIG. 23, we show details of Ganaka described in this application. F23_GMM (F24_MOM_100 of our first patent application), is the global model memory, storing multiple models for multiple datapoints in F23_GDM (data memory—F24_DPM_100 of our first patent application). These models are derived using convex hull/clustered/approximate convex hull or other approaches (other than convex hull) in module F23_CHCHAH.

F23_GMM may include possibly apriori constraints from a constraint poll GCP (not shown for brevity), which in turn are optionally translated by F23_XFORM using linear/affine/quadratic or general namespace transformations.

All models can be transformed preserving information content, approximated using convex approximations, . . . , as described by us previously. These transformations impact processor/memory/i-o usage, and can be used to reduce such usage and/or improve accuracy based on additional resource usage. In PCT/IB2019/001296, we show a 35% reduction in memory using convex approximation, and additional numbers are in the enclosed draft publications.

F23_EE (the inference engine of F24,_IE) executes Ganaka's instructions, on one or more cores, after ascertaining resource needs, exemplarily based on machine learning on prior (training) examples. The cores in this exemplary embodiment are RISC cores, but they can equally well be CISC or even analog accelerators controllable in an analogous manner.

Each core has access to a portion of WCS (which may or may not be shared between cores), and uses this to run the operation on operands in F23_GMM, or approximations of them. Each core can pre-empt other cores, if it finishes earlier, and the results impact ongoing calculations at other cores.

7.7.2.1. Exemplary Architectural Elements

In the exemplary embodiment, we can have the following architectural elements:
Each core (F23_ANB is one of them), is a conventional RISC processor, controlled by the WCS.
A 64 bit high speed DDR 5 interface F23_HSI to the data memory
The nonblocking interface F23_IXC_NB enables Ganaka's IE to:
   Work on operands even when they are only partially available.
   Connect to any accelerator, e.g. a GPU, a DSP, a Boltzmann machine, . . . .
F23_INV is an inverter, creating in principle new datapoints from models.

The interconnect F23_IXC_NB is conventional (possibly a bus, a crossbar/other network, . . . ), except that the datapoint interface is high speed (Hadoop/HFS/Apache Sparx/ . . . ), and the low speed model interface F23_IXB_NB and ALU F23_ANB is non-blocking, allowing computation to access partially loaded data (which can be large, but still very small compared to the datapoint memory).

The IE (F23_ANB, and sibling cores), and model memory F23_MOM_NB, is specially configured to be non-blocking in delivery of data, and execution. A model is of highly variable size, and so is the execution time required, depending on the complexity of the model. As such a pipeline with a fixed clock cycle/latency is challenging to design for this. Instead, a partially self timed (but exemplarily still clocked synchronous) system is appropriate.

Even with self timing, many variants are possible, ranging from simple architectures where memory access and computation wait till
a. A fixed size block of data (same for all models) is available.
b. A block of data, whose maximum/minimum size is dependent on the model (and stored in the model header in model memory—FIG. 24 of our previous patent application), is accessed. Different pieces of the model can have different maximum/minimum block sizes.
c. A block of data of arbitrary size (depending on the model, the machine state, occupancy on the bus/other interconnect, is accessed),

After computation begins, other possibilities exist
a. The computation can be run until completion (this can be done if a fixed upper bound on time is obtained through measurement or otherwise).
b. A partial answer (e.g. a bound) can be given for further processing of other Ganaka instructions (e.g. inference from an I-structure—see FIG. 25).
c. The computation is pre-emptible, with exemplarily a fixed maximum time per computation round, depending on the model (also stored in the model header). Again, different pieces of the model can have different maximum times. Maximum/minimum time allocatable per slice, can also change between rounds, depending on the model, as well as the computer system state (well known in the state-of-art).

An exemplary control flow is as follows:
The IE signals to the MOM what is the minimum amount of data (exemplarily vector size, number of variable size constraints, . . . ) is required for it to begin the next step of computation.
Model memory will exemplarily interrupt the processor after each such specified data chunk is delivered.
IE proceeds with computation, until such time as the computation is completed, or inferable (e.g. even if one constraint of a LP is violated, no further work need be done).
The enhanced I-structure is updated.

With multiple memory banks, and cores, the maximum and/or minimum time slices/block sizes can additionally depend on the memory bank, as well as the core. Memory organizations varying from UMA (uniform memory access) to NUMA (non uniform memory access) offer additional design opportunities.
The entire computation system can be partially statically scheduled (except for processing of non-convex models), like a VLIW system.
Priority scheduling can be used, especially for motion control real time applications as per our U.S. Pat. No. 7,348,754, India patent 261790, and successive patents and patent applications, where the design and control of dynamics of electrical mechanisms is discussed.

High speed possibly convex approximations can be speculatively executed, in idle cores, and the results used by IE to infer the other computations.

7.7.3. Additional Architectural Features

Multiple models can exist for the same (set of) datapoints (some or all in the enhanced I-structure). As such evaluation of set-theoretic and information-theoretic operators can be exemplarily done in parallel using the different models, on multiple cores/threads. High-speed possibly interrupt based communication facilitates the sharing of results/partial results between the cores/threads.
For example, let a simple model M2 (maybe a N-dimensional box) be a superset of model M1 (maybe a complex neural network/Graphical Model). If M2 is disjoint from model M3 (and this can be found fast), then M2 is automatically disjoint from M3. Ganaka fires off cores/threads for determining disjointness between (M1 and M3), and (M2 and M3), in parallel. The second thread (computing disjointness between (M2 and M3)), will finish quickly, and will communicate to the first thread (computing disjointness between (M1 and M3)), to stop any future work.
A similar approach can be used for searches, where fathoming is used to cut off branches which can be proven to be suboptimal quickly. Such a method is used in MILP (mixed integer linear programming), where branches whose LP relaxation is suboptimal compared to another, are not explored.
If the time/memory/i-o used to evaluate an operand exceeds a maximum limit, then it can be pre-empted, and/or a simpler model used (e.g. a convex approximation, a bounding box, . . . ).

Any other architectural organization, enabling variable size operands, and variable time computation can be used. As previously mentioned, classical versions of these optimizations, are extended by the ability to transform models into each other.

While at Ganaka's architectural level, this is the CISC philosophy taken to an extreme, the huge saving in data volumes due to modeling/generalization, more than compensate for this. Many classical aspects of computer architecture have analogs in Ganaka, and we describe a few below.

7.7.4. Model Generation from Data Samples: Convex Hull and Approximations

FIG. 24 shows data memory and model memory where the model memory is an exact or approximate convex hull of blocks of datapoints.

As per the discussion in Section 7.2, 7.3, and 7.4, convex hull models avoiding the exponential number of facets can be generated using the implicit representation from vertices. Even here, memory can be reduced by orders of magnitude compared to the raw datapoints, by keeping only those points on the convex hull boundary, and not those in the interior. Identification of a point as belonging to the interior of the hull, can be done by linear programming. A full blown LP for each new datapoint can be exemplarily avoiding by testing only a sample of datapoints (Table 1 and its extensions). This and other optimizations based on subset identification and integer linear programming, are in a high speed configurable filtering module (F24_VPF), analogous but possibly different from the WCS, as it has to handle a high speed input datastream.

In the model memory, only the datapoints corresponding to the implicit hull boundary are pointed to and/or stored, yielding extensive memory compression (orders of magnitude compared to the raw datapoints), and much more, (exponentially less) compared to the number of explicit constraints (facets).

An analogous filter is used for an implicit general convex/non-convex model, with only datapoints on the model “boundary” being pointed to/stored in the model memory.

The technical problem being solved is data modeling using a convex hull or other model implicitly specified by datapoints, using only the specific datapoints affecting the convex hull or other model. The number of these specific datapoints is orders of magnitude compared to the datapoints, and exponentially smaller compared to explicit constraint specification (or equivalents for models other than the convex hull). This reduces storage, power, i-o, simplifies the pipeline, . . . , a technical improvement.

Of course, models can be specified apriori, independent of data samples.

Models can be convexified. Convexification of operands given to general operators enables approximate answers to be given quickly. The exact/approximate nature of these answers are marked in an array, exemplarily in Ganaka's scratchpad/temporary memory (FIGS. 21 (a) and (b)). Further improvements in approximate answers can be exemplarily carried out iteratively.

At all stages, we can use/store models/answers in virtualized format, to facilitate reuse in other situations (see Section 7.7.5).

7.7.5. Virtual Models, Translatable Using Linear/Affine/Convex/General Maps. Square, Rectangle, Quadrilateral, Rhombus, Bulged Square, General

Models can be transformed into one another, using a variety of transformations (linear/affine/convex/general maps, including namespace translation as per our preceding application No 201841039665 “Ganaka: A Computer Operating on Models, filed on 19 Oct. 2018”, now PCT/IB2019/001296). For example, we can have a set of squares, based on a generic unit square centered at (0,0), and then concrete “subclass” squares instantiated using:

M0: −0.5<=x1<=0.5,−0.5<=y1<=0.5

M1: MO scaled by 3, translated to (10, 5), in variables x2,x12//This stands for a square of size 3, centered at (10,5), in variables (x2, x12)

M3: M0 scaled by 3, translated to (1.1,2), in variables x3+x4\hat{ }2, x8+x9\hat{ }3//This stands for the (non convex) model

−1.5<=(x3+x4\hat{ }2-1.1)<=1.5

−1.5<=(x8+x9\hat{ }3-2)<=1.5

M4: M0 scaled by 2, x1 integer. //This stands for 3 lines [−1<=x1<=1;−1<=y1<=1;x1 E [−1,1]1

In memory, only a single generic model needs to be stored, and others can be generated as needed using these transformations. Relational algebra can be based on either the explicit and/or the abstract model, and stored as such in the Enhanced I-structure.

The transformations are hence succinctly represented—conserving model memory/i-o, speeding up the IE by improving hit rates in the enhanced I-structure by recognizing virtual operands as equivalences, . . . .

7.7.6. Instruction Windows, and Optimal Scheduling of Instructions in a Window Ganaka's instructions are characterized by extreme variations in resource needs—time, memory, i-o, . . . , and can be executed in a variety of different implementations, ranging from a RISC/CISC core controlled by the WCS, to analog implementations like Boltzmann machines. As such partitioning of the available resources amongst different instructions in the instruction stream is critical in determining performance, and exemplarily includes the following facilities, as well as many more.

In addition to reordering respecting RAW, WAW, WAR hazards, we have resource exceeded reordering (equivalent to OOE), in a window of instructions. Estimates of required time/memory/ . . . can be made, based on model size/complexity. Resources can be partitioned unequally amongst different instructions, with heavier instructions getting more.

In an embodiment, we have a stream of Ganaka instructions, in a window of a maximum size W. These instructions are composed of simple operations (equality, inequality of data samples), to complex set theoretic (e.g subset), and information theoretic calculations in graphical models. Associativity, transitivity and other properties can be used to evaluate answers to all operations in the window, based on answers/partial answers to others in the window. The enhanced I-structure as per our preceding patents/publications/patent applications is one architectural element to accelerate these inferences.

Operations are in priority order. Exemplarily, in each cycle, we execute:
1. Shortest Instructions First—quickest answers are given first, with operators with complex non-convex operands, being given lower priority, based on the elapsed time/estimated time using machine learning. For such operators, we can quickly give approximations based on exemplarily convexification, and use these for the inferences in step 2 below.
2. After an answer is obtained, inferences for the entire sequence of operations in the window are made/updated.

Ganaka repeats this process till the computation of all instructions in the window is completed. FIG. 25 illustrates this. With reference to FIG. 25:
Dynamic Sized Instruction Windows. F25_IW1, F25_IW3, F25_IW3 depict successively smaller instruction windows, as the first one has a large number of short instructions, and F25_IW3 has possibly just one heavyweight instruction. Essentially we have Instruction Admission Control analogous to Call Admission Control in telecommunication switches.
Operand fetch over the interconnect (F25_IXC_NB), IO, and Instruction Executions (F25_ALU_NB, F25_EE), are non blocking, and can be carried out as soon as the minimally required portion of input arrives (like a dataflow system).
   For example, computation of a MV product Ax can be carried out as soon as a single row of A, and vector X arrives to the portion of IE (inference engine), handling MV products. This is unlike static scheduling, since the number of the non-zero elements of A can be highly varying from row to row.
As long as the sizes of models are known apriori, the memory access, the interconnect and 10 systems, and to some extent the IE engine, can be pre-scheduled statically, as in a VLIW system.
   The IE processing for non-convex models may require computationally expensive searches, and is challenging to schedule statically.
   Model Convexification and other approximations can be immediately carried out, exemplarily using LP relaxations, dropping constraints, lagrangean relaxations, etc, and the enhanced I structure updated.

Enhanced Inference Structures as per our prior patent applications (F25_EIS), are updated as soon as an answer/partial answer is generated.

7.7.7. Summary Operation of Exemplary Ganaka Embodiment

Based on all the above, Ganaka's exemplary embodiment operates as follows (see FIG. 2, FIG. 14, FIG. 24, FIG. 25):
Ganaka derives models from data, based partly on apriori information.
   If a convex hull/clustered convex hull/approximate convex hull model is used, either an implicit or an explicit model can be employed.
   If an implicit model is used, the number of datapoints stored in either the data or model memory can be further reduced by identifying points on the convex hull boundary, and storing them only. This extends to general models also.
Models can be converted into other models, using information preserving transformation techniques, and additionally using namespace translation, and virtualization, as described by us previously.
Ganaka takes a dynamically changing (in size) window of instructions, and partitions and schedules them on the available computation resources, which may be heterogeneous (including analog implementations).
   The extensive variability in timing may require machine learning techniques for prediction, and partially self-timed non-blocking operation in processing, operand access, and io.
After an answer/partial answer/approximate answer (based, say on convexification), is obtained the enhanced I-structure is updated, to aid processing of other instructions.
The invertor can derive additional data samples from models. The implicit convex hull representation for a D-dimensional sample space, is convenient, since we need to randomly sample a D-dimensional vector between 0 and 1 only.

7.8. Possibly Approximate (Possibly Analog) Dot-Product

Approximate (possibly analog) Dot-Products reduce power and can be significantly more energy efficient. This is useful in reducing power/computation needs at the front end, where voluminous data arrives for modeling. Data satisfying the model need not be stored (unless needed for other purposes).
Membership in convex models with an explicit half-plane characterization (Ax<=b) can be efficiently evaluated using a conservative approximate dot-product, where the approximate calculation yields A′x<=Ax. A datapoint is a member of the model, if A′x<=b, and can exemplarily be omitted from being stored.
Convex models specified as the convex hull of datapoints, require solution of an LP to determine membership of a point. Instead, a DNN learning to solve an LP approximately, can be used.

7.9. Non-Linear Feature Extraction and Inversion of Features

The discussion below refers to our preceding application No 201841039665 “Ganaka: A Computer Operating on Models, filed on 19 Oct. 2018 (now PCT/IB2019/001296), Section 12 and 13.

A critical feature of modeling is data reduction using a model. However, in many applications, especially with extensive nonlinearities, explicit datapoints are required. The description below shows how such datapoints satisfying the model, can be done in the case of DNN (Deep Neural Networks), preserving a variety of desirable properties. We describe first the general features through an example, and then the architectural/technological invention.

FIG. 26 shows a non linear model which has two equations and three unknowns (underdetermined system). The figure shows a non-linear feature extractor, which takes four-dimensional vectors as inputs, derives features using non-linear transformations such as sigmoid, RELU (non-linearities are denoted by the transformation f) . . . and produces two-dimensional feature vectors for every input.

Consider an input (x₁, x₂, x₃, x₄) to the non-linear feature extractor.

In the forward pass, the first layer outputs are given by:

$$y = f ( {W}^{( 1 ) T} x ) ( or ) \\ {y}_{j} = f ( {\sum }_{i} {w}_{ij}^{( 1 )} {x}_{i} )$$

The final layer features are given by:

$$z = f ( {W}^{( 2 ) T} y ) ( or ) \\ {z}_{j} = f ( {\sum }_{i} {w}_{ij}^{( 2 )} {y}_{i} )$$

Given a sample in the feature space (z space), it is possible to produce new input samples using non-linear optimization methods, since the non-linear feature transformation is a many-to-one mapping.

Consider a sample (z₀, z₁) in the feature space. On the inversion of non-linearity, we have:

u₁=f⁻¹(z₁)=Σᵢwᵢ₁⁽²⁾yᵢ and

u₂=f⁻¹(z₂)=Σᵢwᵢ₂⁽²⁾yᵢ

Since yᵢ s are outputs of the non-linear functions, these will typically be constrained. For example, if the sigmoid non-linearity is used,

0≤yᵢ≤1∀i

The Rectified Linear Unit (ReLU) activation is the most commonly used activation function in deep neural network systems. The ReLU activation is given by:

ReLU(yᵢ)=max(0,yᵢ)

For the ReLU non-linearity, following inequality constraints is used

0≤yᵢ∀i

For the non-linear model shown in FIG. 26, this system has two equations and three unknowns (underdetermined system). Therefore, there can be several possibilities for y. These different values of y on one more inversion step can produce new image samples.

The second inversion step to generate new samples in input space,

v₁=f⁻¹(y₁)=Σᵢwᵢ₁⁽¹⁾xᵢ,

v₂=f⁻¹(y₂)=Σᵢwᵢ₂⁽¹⁾xᵢ and

v₃=f⁻¹Σᵢwᵢ₃⁽¹⁾xᵢ

The inputs may also be constrained, for example, images (unnormalized) have pixel values between 0 and 255,

0≤xᵢ≤255 ∀i

This system is also underdetermined with 3 equations and 4 variables. Hence, different possible input samples can be generated from the same feature sample z.

Typically for image classification Convolutional Neural Networks are used. A single convolution layer is depicted in the Errorl Reference source not found. FIG. 27 below.

FIG. 27 shows convolutional layer in a convolutional neural network with input of size 224×224 x 3 and a feature map of 224×224×64. The operation performed is conv(3×3,64). An RGB image of dimensions 224×224 is passed through 64 convolutional filters with kernel dimensions 3×3. This convolutional layer produces a feature map with 64 channels and of dimension 224×224.

The number of equations is equal to the number of units in the output i.e. 224×224×64. However, the number of variables is equal to the number of units in the input i.e. 224×224×3. Clearly, the number of equations is greater than the number of variables. This system is overdetermined, and by itself permits only a single solution, the original image one begins with.

However, the standard practice in deep learning systems is to couple convolutional layers or stacks of convolutional layers with pooling layers, which are many-to-one mappings. This pooling layer enables us to add inequalities to the constraints to effectively invert these convolutional networks.

FIG. 28 shows convolution operation followed by max pooling operation. It shows an image padded with zeros passed through a 3×3 convolutional layer followed by a 2×2 max pooling layer.

FIG. 29 shows the convolutional filter with weights wij. Xij indicates the pixels in the image. p, q, r, s are the result of applying a convolutional filter with center of the filter placed on x11, x12, x21 and x22 respectively.

FIG. 28 shows an image padded with zeros passed through a 3×3 convolutional layer followed by a 2×2 max pooling layer. FIG. 29 shows the convolutional filter with weights wij. Xij indicates the pixels in the image. p, q, r, s are the result of applying a convolutional filter with center of the filter placed on x11, x12, x21 and x22 respectively. a, b, c, d, e′, f are the maximum values in the respective 2×2 windows scanned by the max pooling layer. For example,

a=max(p,q,r,s)

An inequality of the following form can be applied to invert the pooling map to obtain pixel values in the original image:

p=w₂₂x₁₁+w₂₃x₁₂+w₃₂x₂₁+w₃₃x₂₂≤a

Inequalities from multiple DNNS maxpool layers can be used to create an underdetermined system. In addition, the convex hull of the features in the feature layer, can be sampled to generate alternative features in the same class, which can be additionally inverted to yield more confusing examples.

I.1.1. Applications of Nonlinear Inversion

Nonlinear transformations can be considered in the realm of classification, regression, and in general any machine learning application. We illustrate uses in classification.

A new sample which belongs to the same class as represented by the feature vector z can be generated using the minimization criterion:

$${min}_{x} {‖ x - o ‖}_{2}$$

Where x is the input sample to be generated using the above linear equations/constraints and o is a sample belonging to the class represented by the feature vector z.

Adversarial examples can also be generated using a minimization criterion, such as,

$${min}_{x} {‖ x - a ‖}_{2}$$

Where x is the input sample to be generated using the above linear equations/constraints and a is a sample belonging to a class other than the class represented by the feature vector z. We can also generate samples which are close to any data point not present in the original dataset, by choosing an appropriate sample a (Section I.1.2 has an example).

Some more applications include
The non-linear feature inversion module can be used to test the robustness of the non-linear model by generating adversarial examples or examples which do not belong to any of the classes.
The nature of adversaries on varying attributes of the non-linear feature extractors: architecture, number of hidden units, number of layers, non-linear function, . . . , can be studied.
The change in adversaries for different classifiers can be studied.
Adversaries can be generated using a different minimization criterion: L₁ distance norm, L∞ norm . . . .
We can also improve speed and reduce power consumption, by reducing the accuracy of the calculations (say, 4 bits instead of 8-bits), and observe the behavior of adversaries.
In conjunction with memory system/CMdB non-linear transformations, these inversions can be used to map features in the transformed space to the input space.
It can also be used to understand the effect of inversion on feature vectors which lie in the intersection of two or more different classes.

I.1.2. Confusable inputs

The same facility can be used to test if the classifier is robust, in that small changes to features at the classification (final) layer, do not change the input dramatically or the same set of features do not have alternative input classes—i.e. very different inputs don't have a risk of being classified together (checking if confusable inputs exist).

FIG. 30 shows how the same feature in feature space, when inversely mapped to the input space can produce inputs, but one of them belonging to a certain class in the original input space and the other belonging to another class in this space/not belonging to this space. In the illustration, x0 is a point in the input space, x1 belonging to none of the original classes. However, the neural network produces the same outputs (features) for both points x0 and x1. With the one-to-many inverse mapping of neural networks we can construct confusable inputs, such as the point x1 shown in the Figure.

FIG. 30 shows confusable inputs using same features. It shows two input mappings referred as F30_IM. F30_FSC refers to feature space cluster. The ability to invert nonlinear transformations yields a device, which given original data in a certain class, produces new data corresponding to the same class, or a selected different class. The new data can be forced to “resemble” original data according to a metric.

We use the facility of inversion to generate confusable inputs as shown in FIG. 30. We show examples of confusable inputs generated using inversion on a neural network trained to classify MNIST handwritten digits. This neural network has 784 units at the input layer, 500 units in the second layer, 100 units in the third layer and 10 classification units in the final layer. The non-linearity is the sigmoid function. Non-linear features extracted from the third layer are inverted to obtain a confusable input.

Below we describe examples of confusable inputs.

Consider two classes, say, class A and class B. Starting with the non-linear feature representation of an input I1 in class B, we can derive an image I2 in class B which is closer (in L2-distance measured at the input layer) to an image in class A than I1. The image I2, generated using inversion, is a confusable input. A human can classify it as belonging to any of the classes A or B whereas the neural network classifies the image as belonging to class B with the same confidence as input I1.

In FIG. 31, Class A is 3 and class B is 8. The image on the left is the starting image I1 and the image on the right is the inverted image I2. The inverted image is a confusable input-humans are likely to classify it as 8 or 3. However, the neural network will classify this example as an 8 with the same confidence as the image of 8 shown on the left. PGPubs, CRC per instructions from the PTO.

FIG. 31 shows example of inversion with original class 8 on the left and confusing class 3 on the right.

FIG. 32 shows the graph of feature representation of the starting image I1 (belonging to class 8) and generated confusing example 12. The plot clearly indicates that the feature representations of these two inputs are identical.

FIG. 32 shows the graph of feature representation of the starting image I1 (belonging to class 8) and generated confusing example I2. The plot clearly indicates that the feature representations of these two inputs are identical.

FIG. 33 shows another confusable input where class A is 8 and class B is 9. The starting image, belonging to class 8, is shown on the right and the confusable input on the left. In this case, humans are likely to classify the confusable example as 9 whereas the neural network classifies it as 8.

FIG. 33 shows an example of inversion with original class 8 on the left and confusing class 9 on the right. FIG. 34 shows an example where the starting image belongs to class 4 and the confusable input generated is constrained to lie close to an image of 0. Since the classes 0 and 4 are widely separated, the confusable input appears noisy, yet the neural network predicts it as 4 with high confidence.

FIG. 34 shows an example of inversion with original class 4 on the left and confusing class 4 on the right. This facility can be used to compare different architectures for the potential of confusability-architectures with high fan-in at the last (feature) layers have high potential to generate confusable examples, which are not pure noise (the large fan-in makes the inversion underdetermined)

The inverter (FIG. 35, but with F32 as an erroneous label prefix to be corrected) in Ganaka's embodiment has hardware support for inversion. In an exemplary embodiment, it is present in the WCS itself (or another auxiliary WCS operating at high speed, since datapoints are voluminous), controlling the same or another auxiliary RISC core.

II. Programming Interface for Ganaka

The large number of facilities in Ganaka can be automatically scheduled (using exemplarily machine learning, and/or controlled using a programming language interface. The programming language interface, implemented by the controller in FIG. 6 and FIG. 7 specifies the sequences the use of either point data, models, or both. The programming interface uses Ganaka's instruction set, which is described below.

An exemplary API and program to determine where the convex and graphical models agree on a new datablock BL is shown in FIG. 36. The first step is to determine if the number of calls is greater than a threshold K, in which case, we bring the entire API package into microcode ROM/WCS for higher speed, lower power, . . . . After determining the agreement set, the program updates the I-structure, calculate the points of agreement of modules, summarize it, visualize it, and invert to get another datablock where both models agree, is shown below (and can be built on top of RISC/CISC architectures, as per the current state-of-art). Both blocks (if size is less than a threshold), and models are sent over an i/o link.

II.1. Ganaka Instruction Set Architecture ISA

Ganaka's ISA is specified with reference to FIG. 37. F37_MEM refers to memory for both datapoints and models, F37_ALU refers to ALU for the models and F37_IE refers to inference engine (i-o is not shown to avoid cluttering the diagram).

As described in the application No PCT/IB2019/001296 “Ganaka: A Computer Operating on Models”, filed on 19 Oct. 2018, Ganaka works on data models, and sequences of data models. Sequences of data model objects (points, convex sets, graphical models), comprise the definition of data, as sequences of instructions define a program. Multiple sequences of data models can define the same entity, and are chosen under user or automatic exemplarily machine learnt control. Ganaka's ALU (and specifically the IE) has methods to handle all the different types of data models which can appear.
At one extreme data is a sequence of atomic entities (singleton models) as in conventional machines.
At the other extreme is a bounding box in each dimension (hypercube model)—a very rough approximation, with extensive compression.
In between we have the convex hull, approximating convex polyhedral, graphical models, . . .
A given data sequence can be represented as a sequence of models in multiple ways, with different properties.
Ganaka flexibly moves between one representation an another
Ganaka creates different representations depending on the application, and exemplarily has a module to recognize interesting patterns. This module may exemplarily be based on algorithms machine learnt from experts in different domains—experts typically are consistent in the display of their expertise (Srinivasa Ramanujan excelled all the time in mathematics), and hence their brains have algorithms fundamentally suited for the domain.

Ganaka's operations are similar to a conventional computer's operations, but use models in addition to atomic operands, each model representing a set of atomic entities. The semantics for models are generalization of those on atomic entities. They can be defined as the result of any set operation being the set obtained by performing the operation on each single or pair of atomic entities in the two sets.

However, they need not be, and typically are not implemented in this manner, but by special algorithms for each operator.

These algorithms can be quite complicated (especially for graphical models), and may be implemented in hardware/FPGA/ . . . . In one embodiment, downloadable microcode forms part of the processor instruction set, like writeable control stores (WCS), closed coupled FPGA's/co-processors. However, unlike conventional machines, the microcode is visible at the application level, using APIs, and can be loaded from instruction RAM under programmer control. The microcode can incorporate altered sophisticated processor/memory/IO scheduling (e.g. FCFS, Earliest Deadline First, . . . ) also, due to the extensive variability of operator/memory/io usage., possibly making the machine suitable in some embodiments for hard real time applications.

Clearly these facilities can be provided for all levels of the instruction/data memory/io hierarchy in IE—microcode, nanocode, L1/L2/L3 cache, . . . . This is feasible, since the basic operations being speeded up are heavyweight, and programmer based control is feasible, in addition to automatic facilities analogous to instruction-cache LRU. The bandwidth between the writeable control store and the instruction RAM is exemplarily large, and the instruction RAM access pipelined, as a high speed WCS can be quite small compared to instruction areas of instruction RAM. Of course the WCS have very high speed access to the IE for high speed execution.

In addition, efficient instructions exist to synchronize the data with corresponding models (if derived from data). Ganaka's ISA is shown in the self-explanatory Table below (in most cases, X? stands for an atomic entity and M? for a model, and &X, &M are addresses—any differences are evident from the instruction semantics).

TABLE 2
Ganaka ISA (X? stands for datapoint, M? for model, &X,
&M are pointers to the datapoint/Model Data in Memory).

| Type | Op1 | Op2 | Result | Remarks |
|---|---|---|---|---|
| Arithmetic/logical | X1 | X2 | X3 | |
| Arithmetic/logical | M1 | X2 | M3 | |
| Arithmetic/logical | M1 | M2 | M3 | |
| Set-Theoretic | M1 | M2 | M3 | |
| Information | M1 | | Scalar | |
| Estimation | | | | |
| Information Eq | M1 | | M3 = M1′ | |
| Transformation | | | | |
| Information | M1 | | M3 | |
| Increased | | | Vol(M3) <= | |
| Xform | | | Vol(M1) | |
| Information | M1 | | M3 | |
| Decreased | | | Vol(M3) >= | |
| Xform | | | Vol(M1) | |
| Conditional | X1 | | Boolean | |
| Conditional | M1 | | Boolean | |
| Branch | | | | |
| Conditional Branch | Boolean | | | Other |
| | | | | Conditionals |
| | | | | possible |
| | | | | also |
| Memory Read | &X1 | | X3 | |
| Memory Read | &M3 | | M3 | |
| Memory Write | X1 | | X3 | |
| Memory Write | &M1 | | M3 | |
| Estimate Model | &X array | | M3 | |
| Update Model | &X array | M2 | M3 | |
| Approximate Model | M1 | | M1′ | |
| Delete Model | M1 | | | |
| Initialize Enhanced | | | | |
| I-structure | | | | |
| Update Enchanced | | | | |
| I-structure | | | | |
| (call program) | | | | |
| Delete I-structure | | | | |
| Space for ISA | | | | |
| Extensions | | | | |

Arithmetic and Logical Operations

M3=U[x3=x1 op x2, where x3 is an atomic entity in the model set (Model_3) obtained by choosing x1 in Model_1, x2 in Model_2, and then applying “op”]

Consider addition of models. If Model 1 and Model 2 are polyhedral, Model 3 is also polyhedral. However, while testing x1 and x2 for membership in Model 1/Model 2 is just a matrix-vector product A1 x1-b1, A2 x2-b2, it is not so for Model 3 (involves an LP).

X3=x1+x2;A1x1<=b1,A2x2<=b2;

Ganaka has fast hardware for this purpose, to convert the representation for x3 into a canonical representation A3 x3<=b3, depending on application.

These instruction classes below have notation similar to arithmetic and Logical Operations

Set-Theoretic Operations

Information-Theoretic Operations

Conditional Operations

Memory Operations . . . Direct/indirect Addressing/Model driven Addressing/ . . . .

Memory operations have the important aspect of model driven indirection—the model can point to another coarser/finer model.

Modeling Operations

These are critical, in that modeling is the core of the system. Ganaka has fast facilities for deriving polyhedral, graphical and other models (these are essentially finer and finer approximations), corresponding to viewpoint (b) in Section 4.1.

III. A 64-bit embodiment operating at 1 GHz

FIG. 38 shows details of a 64-bit embodiment of Ganaka, with block labels following our convention <Figure #_ShortName>. The high speed data interface F38_HSI is 4-way, with each way being 64 bits, clocked at DDR5 rate of 6.4 GHz/transfer's per second (25.6*64 bits/second). This voluminous datastream is modelled, and reduced to a single 64-bit multiplexed model bus, operating at 1 GHz, with pre-emption, and 8 priority levels. The Global Data memory F38_GDM, is 32-way interleaved, with each way being 256 GB, for a total of 8 TB of memory (possibly an SSD). The data modeler F38_CHCHAH reduces this to a sequence of models in F38_GMM (one model, say, for each 10 GB datablock), occupying only 1 GB, a reduction in data volume of 8000× (four orders of magnitude). This reduction may be exemplarily by using the reduced convex hull of a block of datapoints, or other means. While the same cores as in the IE can do the modeling, due to the high incoming data rates, a dedicated separate core is preferable.

The execution engines F38_IENB (multicore, RISC, along with digital/analog accelerators F38_AA in this embodiment), work at 1 GHz, and access operands over the model bus, and a kernel WCS of just 16 MB. For polyhedral models, the smallest rows are sent first. The IXC is scheduled by the EE Execution Controller F38_CON, which has the responsibility of scheduling IE, Model memory, and 10. F32_EMEC is a electrical mechanism, connected to the non-blocking interconnect, which schedules emec control operations in real time.

FIG. 39 shows the operation of Ganaka's controller. Model parameters including priority are accessed from F39_CHCHAH, F39_GMM, . . . (an exemplary data layout of a model is shown in FIGS. 21 (a) and (b). An optimal control of the data modeler, global model memory, interconnect, and execution engines is computed, and control signals are sent to each of the modules, analogous to a VLIW word. Depending on the implementation, the control path can be 10's to 100's of bits in width.

If required, new data can be generated to fill the data memory, using the inverter F38_INV (also shown as F39_INV).

Many other design details can be provided, if required.

This embodiment allows answers to be given over the entire set of possible inputs consistent with models, as well as reducing data volumes by four orders of magnitude.

In the attachments (not as part of the description right now), the improvement numbers over conventional architectures as estimated at this time are documented. These are bound to change with time, as better algorithms/more optimized implementations are developed, and the claims extend to them.

The timings for operations in Ganaka vary extremely. For atomic datapoints, a single clock cycle (1 nanosecond), will determine equality/inequality—relational algebraic operators reduce to this). For polyhedral models with 100's of dimensions, we need 100's of milliseconds for the subset operation.

And with non-convex models, the times are indeterminate, and can be very long (and this does not take system variations into account). Information estimation needs MCMC type attached accelerators on the IXC, and can be even more expensive.

Similarly, the model sizes vary from a single 64-bit word for atomic operands (singleton models), to 100 MB for Inception and 500 MB for VGG16 models of Imagenet.

As such the dynamic IE scheduling, saving of partial computed state in temporary memory as in FIGS. 21 (a) and (b) from our prior application, the nonblocking 10 nature of the memory access interconnect, and io, is critically important.

In the attached paper draft, we have estimates (Table 5 therein) and associated description. Ganaka's approach results in memory compression by 2-3 orders of magnitude, and time speedup of 1-2 orders of magnitude on an unoptimized Ganaka implementation. For example, class conflict in ImageNet amongst 20,000 classes can be done in a week, but this is impractical using other methods (1000 days, . . . ).

An end-to-end application utilizing Ganaka's facilities, can exemplarily be a robotic device/self driven car, having a vision system, and a (semi) automatically controlled actuator. Here we have
Vision System for classification and localization, yielding a few bytes as a class identifier/localizer, from a Mbit/second image stream—robust to different poses, . . . .
An actuator control dynamic model, sent to IE over the interconnect—even 1000×1000 matrix will occupy only a few MB.
The modeling incorporates uncertainty in the design and operation of actuators (electrical mechanisms). Hence the control is robust, and can be computed/actuated at high speed/low power, based on Ganaka's modeling, and control of the model memory, IE, and the interconnect IXC (possibly over a dedicated periodic time slot), and our prior art in emecs (electrical mechanisms, also patented).

1. We claim a modeling computer system, with the capability to generate/update/use models of data, in conjunction with data, extending the techniques in per our preceding application No 201841039665 “Ganaka: A Computer Operating on Models, filed on 19 Oct. 2018”, said computer system having facilities for
a. Modeling of Data into sets, polyhedral, convex, or otherwise
b. Generating approximations of said models
c. Operation on said models
d. Generation of new data samples from said models

2. The system of claim 1, having facilities to
Generate an implicit convex hull representation of the datapoints, without explicitly storing the convex hull facets
Reducing the number of datapoints by utilizing points on the boundary of the convex hull of the totality of data points, said reduced number of datapoints obtained by applying a filter to said totality of datapoints.

3. The system of claim 1, having facilities to schedule computations on a plurality of elementary computation engines, said facility offering the facilities of
Fast and memory parsimonious computation for instructions with simple operands.
Fast and memory parsimonious approximate computation for instructions with complex operands.

4. The system of claim 1, having facilities to schedule model memory and interconnect and io access on a plurality of memory banks, said facility offering the facilities of
Fast memory, interconnect, and io access for instructions with simple operands.
Fast and parsimonious memory, interconnect, and io access for instructions with complex operands.

5. The system of claim 4, having facilities to statically schedule memory and interconnect access, given sizes of models, and their priority, real time or non real time.

6. The system of claim 1, having facilities to schedule computations on a plurality of elementary computation engines, said facility offering the facilities of
Fast and memory parsimonious computation for instructions with simple operands.
Fast and memory parsimonious approximate computation for instructions with complex operands.

7. The system of claim 1, offering facilities to generate new data points, from models

8. The system of claim 1, using a RISC core driven by a WCS to implement operands

9. The system of claim 1, using an analog accelerator to filter data satisfying the model.
